(19) United States
(12) Patent Application Publication
(10) Pub. No.: US 2004/0064353 A1
(43) Pub. Date: Apr. 1, 2004

(54) System and method for creating personalized template for monitoring workflows

(76) Inventors: Yeong-Ho Kim, Gyeonggi-do (KR); Won-Chang Hur, Gyeonggi-do (KR); Jea-Yoon Jung, Daegu (KR); Jung-Nam Lee, Gyeonggi-do (KR); Mi-Suk Lee, Seoul (KR); Ho-Seong Song, Gyeonggi-do (KR); Kyung-Won Kim, Gyeonggi-do (KR); Yong-Woon Shin, Seoul (KR); Tae-Ho Lee, Gyeonggi-do (KR); Byeong-Kwon Kwak, Incheon (KR)

Correspondence Address: BAKER BOTTS L.L.P., 2001 ROSS AVENUE, SUITE 600, DALLAS, TX, 75201-2980, US

(21) Appl. No.: 10/416,749

(22) PCT Filed: Aug. 29, 2002
(86) PCT No.: PCT/KR02/01629

(30) Foreign Application Priority Data
Sep. 12, 2001 (KR) 2001/56098

(51) Int. Cl. G06F 17/60

(52) U.S. Cl. 705/8

(57) ABSTRACT

The present invention discloses a system and method for creating a personalized template which enable a person who monitors workflows to selectively set up search objects, analysis conditions and presentation conditions and create and manage an appropriate template. The system for creating the template includes: a template management module for performing functions of creating a new template, opening and using the template, modifying the template and deleting the template; a data object module for providing a user with search variables for setting up search conditions on the template and interest variables for interest items for selecting wanted items from the searched results, storing the search conditions and interest variables set up by the user, and executing search; and an operation module for providing analysis variables and an analysis method for analysis on the basis of the search variables and interest variables set up in the data object module, and executing analysis according to the selected analysis variables and analysis method. As a result, the users monitoring workflows in the workflow system can individually set up the search conditions, analysis conditions and presentation conditions in the template, thereby efficiently analyzing the works.

### TECHNICAL FIELD

The present invention relates to a system and method for monitoring workflows, and in particular to a system and method for creating a personalized template which enables a person who monitors workflows to selectively set up search objects, analysis conditions and presentation conditions and create and manage an appropriate template.

### BACKGROUND ART

In general, a workflow is defined as a whole or partial business process for transmitting documents, information or works from one participant or another participant according to a series of procedures or rules. A workflow system is an automatic system for collectively managing workflows.

Exemplary business processes include insurance contract service works of an insurance company, delivery service works of a delivery company and loan service works of a bank. The workflow system interprets and embodies the business process composed of relations and flows between resources relating to daily works of an organization, so that people can work by following the business process. This is called process definition.

The insurance contract service works will now be explained in detail with reference to FIG. 1. The business process comprises the sequential steps of client order acceptance, contract document preparation, and prepared document approval. In the insurance contract service works, the respective order acceptance, document preparation, and document approval works are unit activities of the workflow. The unit activity of the workflow which is a minimum logical unit composing the process includes human beings, resources and information.

When an insurance contract order is accepted, a process generated according to the process definition is an instance. Therefore, a plurality of instances exist in one process definition. When the instance is performed and ended, information relating to the process instance is stored in an archive.

The workflow system generally provides a function of searching, analyzing or evaluating a process and a person working in the process, including a start time, an end time, a person in charge, a person delaying work, an overdue work, and a time consumed to perform the whole process. Such functions of the workflow system serve to embody economical techniques such as the activity based management and the balanced score card.

However, the conventional workflow system does not satisfy individual demands of users who search, analyze and present information relating to work, but is rather than embodied only in a conventional form.

### DISCLOSURE OF INVENTION

Accordingly, it is a primary object of the present invention to provide a system and method for creating a personalized template which can set up search conditions and analysis conditions upon the request of a user who monitors workflows in a workflow system.

Another object of the present invention is to provide a system and method for creating a personalized template which can set up presentation conditions of search and analysis results obtained under the predetermined search and analysis conditions upon the request of a user.

In order to achieve the above-described objects of the invention, there is provided a system for creating a personalized template for monitoring workflows which is mounted on a workflow server having a workflow engine and a database, including: a template management module for performing functions of creating a new template, opening and using the template, modifying the template and deleting the template; a data object module for providing a user with search variables for setting up search conditions on the template and interest variables for interest items for selecting wanted items from the searched results, storing the search conditions and interest variables set up by the user, and executing search; and an operation module for providing analysis variables and an analysis method for analysis on the basis of the search variables and interest variables set up in the data object module, and executing analysis according to the selected analysis variables and analysis method.

In addition, there is provided a method for creating a personalized template for monitoring workflows which is mounted on a workflow server having a workflow engine and a database, including the steps of: (a) providing a new template for creating the personalized template; (b) providing search variables for setting up search conditions according to kinds of templates, and storing the search variables selected by the user and operation conditions of the search variables in the template; (c) providing items which the user intends to read from the search results as interest variables, and storing the interest variables selected by the user in the template; and (d) providing analysis variables and an analysis method for analysis on the basis of the search variables and the interest variables set up in step (b), and storing the selected analysis variables and analysis method in the template.

### BRIEF DESCRIPTION OF THE DRAWINGS

The present invention will become better understood with reference to the accompanying drawings which are given only by way of illustration and thus are not limitative of the present invention, wherein:

FIG. 1 is a view illustrating a business process for an insurance contract service work;

FIG. 2 is a view illustrating an application state of a system for creating a template in accordance with the present invention;

FIG. 3 is a detailed structure view illustrating the system for creating the template of FIG. 2;

FIG. 4 is a view illustrating an initial screen showing a template created by a template create module;

FIG. 5 is a view illustrating a detailed picture displayed by selecting ‘Insurance Sales Process Analysis’ template of FIG. 4;

FIG. 6 is a view illustrating a picture for setting up search conditions provided by a search condition setup module of a data object module;

FIG. 7 is a view illustrating a picture displayed by an interest variable setup module;

FIG. 8 is a view illustrating search results of a search execute module;

FIG. 9 is a view illustrating a process for selecting independent variables and dependent variables by a variable setup module of an operation module;

FIG. 10 is a view illustrating an example of setting up the independent variables by the variable setup module;

FIG. 11 is a view illustrating an initial screen provided by an analysis method setup module of the operation module;

FIG. 12 is a view illustrating a picture displayed by opening the template whose analysis variables and analysis method are set up by the operation module;

FIG. 13 is a view illustrating analysis results obtained by driving an analysis execute module;

FIG. 14 is a view illustrating a picture for enabling a user to set up a presentation format by driving a presentation module; and

FIGS. 15a and 15b are flowcharts showing sequential steps of a method for creating a personalized template for monitoring workflows in accordance with the present invention.

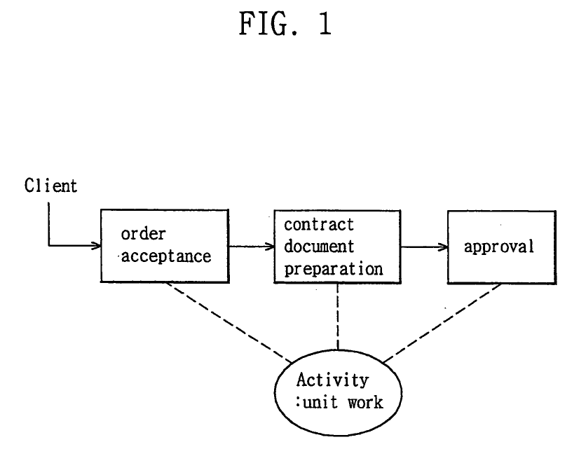

### BEST MODE FOR CARRYING OUT THE INVENTION

A system and method for creating a personalized template for monitoring workflows in accordance with a preferred embodiment of the present invention will now be described in detail with reference to the accompanying drawings.

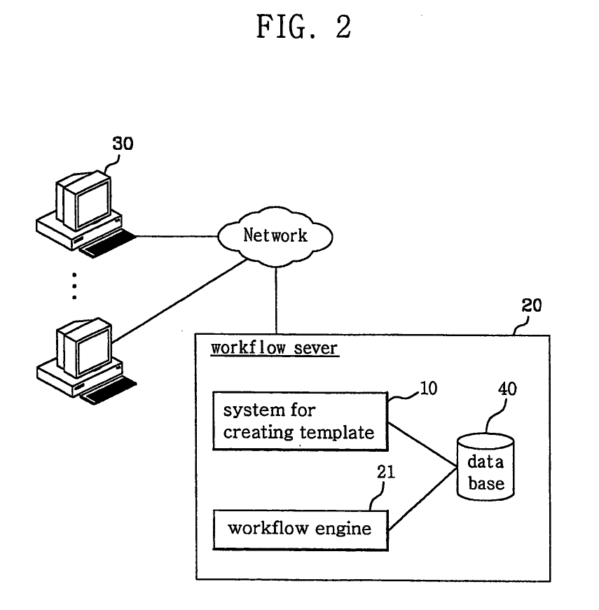

FIG. 2 is a view illustrating an application state of the system 10 for creating the template in accordance with the present invention. Referring to FIG. 2, the system 10 for creating the template is mounted on a workflow server 20, and the workflow server 20 is connected to at least one client computer 30. These systems can access each other through an internal local area network (LAN), wide area network (WAN) or internet network. In accordance with the present invention, the ‘internet network’ implies network groups accessible to each other according to a standard protocol such as the TCP/IP, HTTP, and a wireless internet protocol (for example, WAP). It covers fixture variations including modifications or additions to the existing standard protocol.

The workflow server 20 on which a workflow engine 21 and the system 10 for creating the template are mounted receives and executes a variety of control commands for creating, modifying, storing and deleting the template from the client computer 30, and stores the template in a database 40.

The workflow engine 21 controls works based on the process definition, and receives control commands for adding, correcting, deleting and searching a document file from the client, or operates according to a self-operation. The workflow engine 21 includes an organization management module, a folder management module, a flow control module, a DB storage module and a file management module.

The organization management module performs ID management, and access right grant and deletion (login control) to manage people who join the workflow system.

The folder management module is used to systematically manage items on the process definition. That is, it enables the users to know which process definition exists in which folder. For example, the car insurance process definition, life insurance process definition and fire insurance process definition can be stored in an insurance folder.

The flow control module serves to transmit the control command to the DB storage module or file management module on the basis of the command from the client computer 30 or self-operation.

The DB storage module stores a document file defined in the client computer 30, process definition, version relation between the document files, and correction date and corrector of the document file in the database 40.

The file management module is controlled by the flow control module, and includes functions for adding, correcting, deleting, searching and opening the document to/from the database 40.

The system 10 for creating the template creates a new template, and stores search conditions, analysis conditions and presentation conditions which the user selects for each template. The created template is stored in the database 40.

The database 40 stores data for operating the workflow system, such as the process definition generated by operating the workflow engine 21, archive, instance, user, document file, document history, creator and corrector. In addition, the database 40 stores the template created and modified by the system 10 for creating the template, and also stores a list of variables (basic variables, derived variables and process variables) for creating the template.

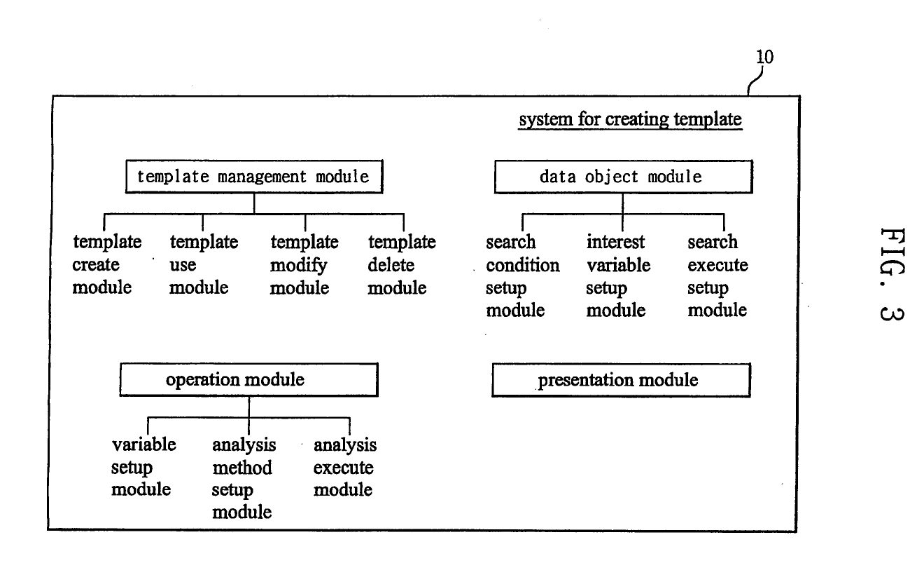

FIG. 3 is a detailed structure view illustrating the system 10 for creating the template of FIG. 2. As illustrated in FIG. 3, the system 10 for creating the template is composed of a template management module, a data object module, an operation module and a presentation module.

In accordance with the present invention, the ‘template’ stores personalized setup information on the search conditions, analysis conditions and presentation conditions which the user sets up for monitoring the workflows, and exists in the database 40 in the form of a file. Exemplary templates include a process definition template, a process instance template, a process archive template, an activity archive template and a user template, which are not intended to be limiting.

The template management module has a template create module, a template use module, a template modify module and a template delete module for executing functions of creating a new template, opening and using the template, modifying the template and deleting the template.

The template create module creates a new template, sets up a property of the template, and stores search conditions and interest variables set up by the data object module, analysis conditions and an analysis method set up by the operation module, and presentation conditions set up by the presentation module. The property of the template includes a name, description, kind, creator and creation date of the template. As described above, the templates are divided into the process definition template, process instance template, process archive template, activity archive template and user template.

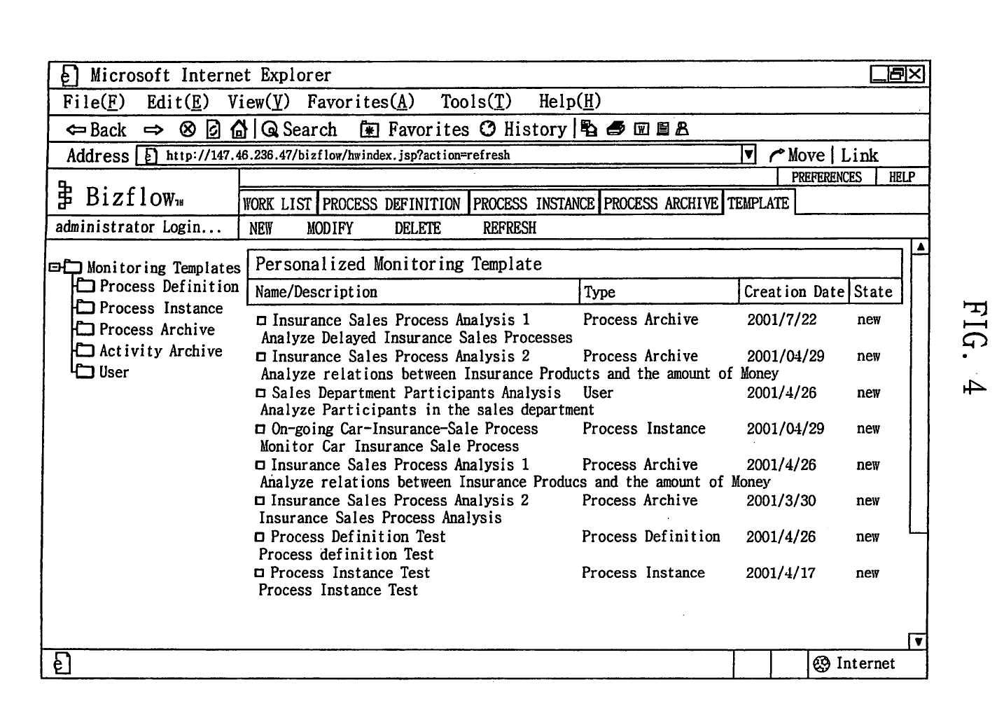

FIG. 4 is a view illustrating an initial screen showing the template created by the template create module.

As depicted in FIG. 4, a name of the first template is ‘Insurance Sales Process Analysis 1’, and a kind of the template is a process archive template. It is also known that the template analyzes an overdue insurance sales process and a creation date of the template is Jul. 22, 2001.

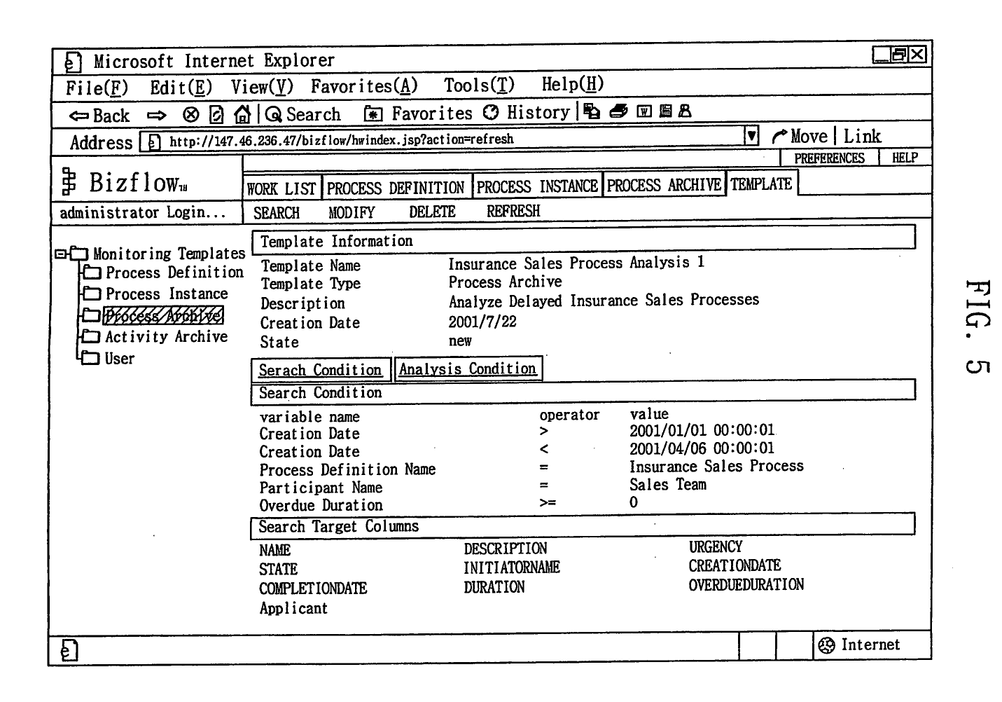

FIG. 5 is a view illustrating a detailed view picture of ‘Insurance Sales Process Analysis 1’ template of FIG. 4. Referring to FIG. 4, an ‘Insurance Sales Process Analysis 1’ template created by the template management module has search conditions and analysis conditions. When the user selects the search conditions (for example, by double-clicking), the data object module is driven to set up the search conditions for the template. FIG. 5 shows a state where the search conditions have already been selected for the template. A process for setting up the search conditions will later be explained.

The data object module includes a search condition setup module, an interest variable setup module and a search execute module, provides search variables for setting up the search conditions on the template and interest items (namely, interest variables) for selecting items from the searched results, stores the search conditions and interest variables selected by the user, and executes the search according to the search conditions and interest variables. That is, when the user sets up the search conditions and executes the search, the search results show information on the interest variables.

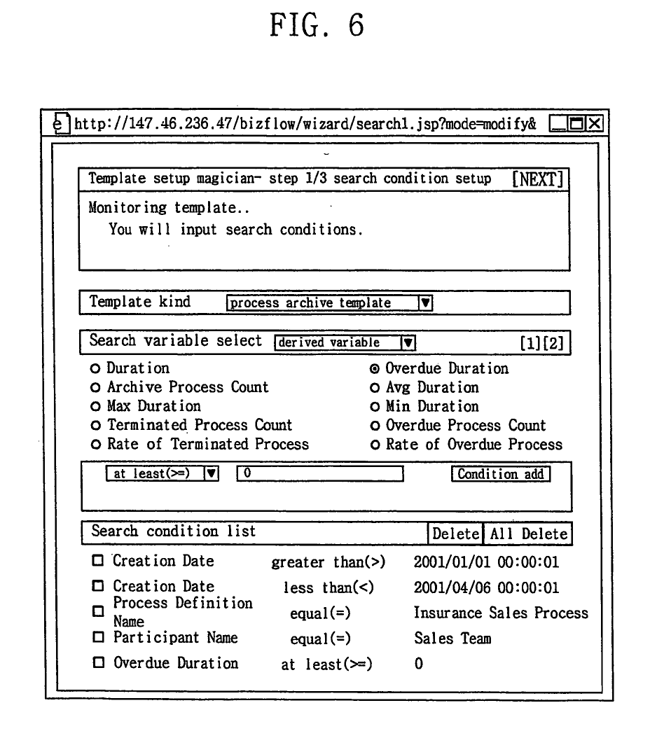

FIG. 6 is a view illustrating a picture for setting up the search conditions provided by the search condition setup module of the data object module.

The search variables provided by the search condition setup module and the interest variables provided by the interest variable setup module include basic variables, derived variables and process variables.

The basic variables are basically provided for each template from the search condition setup module or interest variable setup module. A value of the basic variable is simply read from the database. That is, the value of the data stored in the database is used as it is without executing special operations. The derived variables relate to values obtained by operating more than 2 data values stored in the database. The process variables are provided by the process instance template and the process archive template. When the user performs the process definition by using the workflow engine, the process variables are provided. The user selects the search variables by respectively selecting the basic variables, derived variables and process variables.

FIG. 6 shows the derived variables for the process archive template, including variables such as duration, overdue duration, archive process count, average duration, maximum duration, minimum duration, terminated process count, overdue process count, terminated process rate, and overdue process rate. These derived variables are not intended to be limiting, but may be variously modified by those skilled in the art.

The search condition setup module provides an operator according to the selected search variables, and enables the user to input an operation condition. As shown in FIG. 6, the overdue duration is selected as the derived variable, ‘at least (>=)’ is selected in a combo box as the operator, and ‘0’ is designated as the operation condition. These search conditions can be designated for more than 2 derived variables by clicking a condition add button. Referring to the bottom part of FIG. 6, the overdue duration is selected as the derived variable, and the creation date, process definition and participant name are selected as the basic variables, thereby setting up the search conditions. According to the search conditions, the process name includes ‘insurance sales process’, the creation date exists between Jan. 1, 2001 and Apr. 6, 2001, and the archive process is overdue by the sales team.

When the setup of the search conditions is finished, the user drives the interest variable setup module to set up the interest variables in the search results.

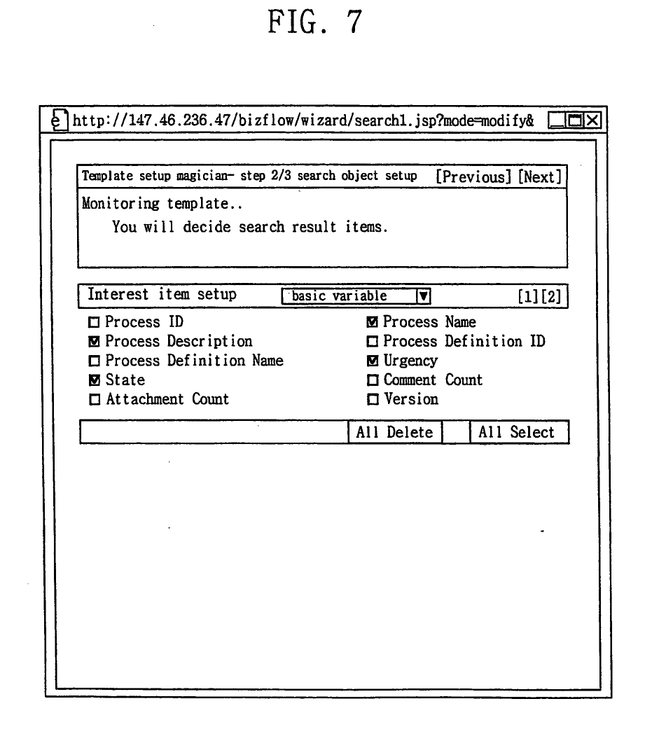

FIG. 7 is a view illustrating a picture displayed by the interest variable setup module. The interest variable setup module provides the same kinds of variables as the search condition setup module. As depicted in FIG. 7, the basic variables include a process ID, process name, process description, process definition ID, process definition name, urgency, state, comment count, attachment count and version count, which are not intended to be limiting. The basic variables can be variously modified by those skilled in the art. The basic variables selected in FIG. 7 are the process name, process description, urgency and state variables. Although not illustrated, in the case where an initiator name, creation date and completion date are additionally-selected basic variables, a duration and overdue duration are additionally-selected derived variables, and an applicant is an additionally-selected process variable, the search execute module will now be explained.

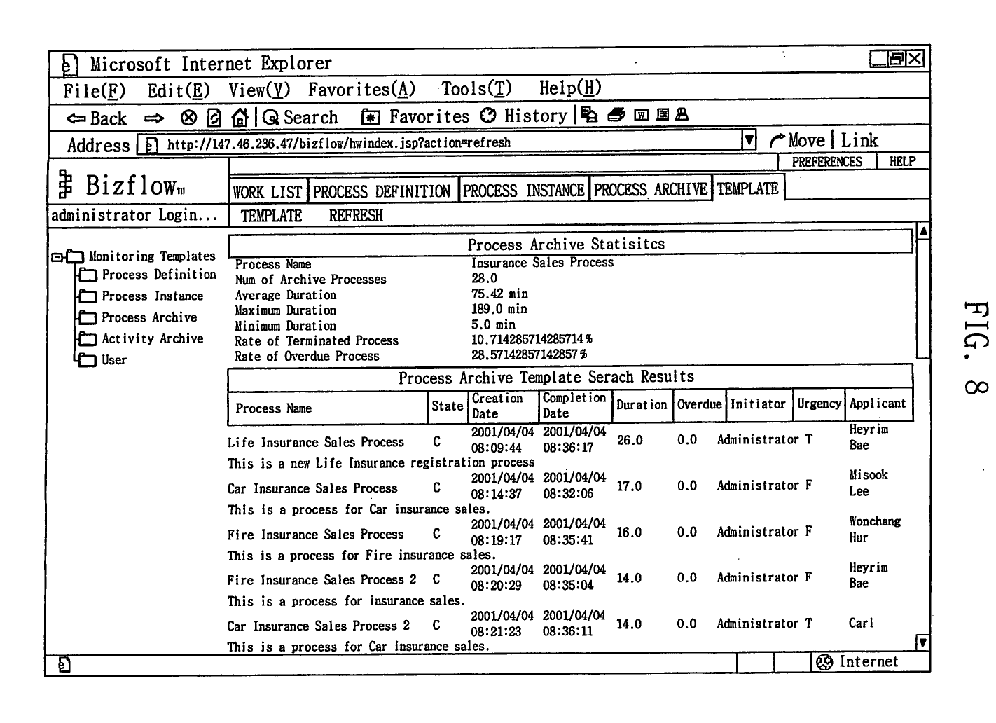

When the setup of the search conditions and interest variables is finished, the user drives the search execute module by selecting ‘search’ from the menu of FIG. 5, and reads the search results. FIG. 8 is a view illustrating the search results of the search execute module. As illustrated in FIG. 8, five archive processes whose process names include ‘insurance sales process’, whose creation dates lie between Jan. 1, 2001 and Apr. 6, 2001, and which are overdue by the sales team, are searched. Each of the archive processes is displayed according to the 10 interest variables set up in FIG. 7.

As described above, when the setup of the search conditions and interest variables is finished by the data object module, the user drives the operation module and sets up the analysis variables and analysis conditions according to the search results.

The operation module includes a variable setup module, an analysis method setup module and an analysis execute module. The variable setup module provides all variables which can be selected as the analysis variables, and enables the user to individually set up independent variables and dependant variables. The dependent variable indicates an item which the user intends to read from the analysis results, and the independent variable has an effect on the dependent variable. It is thus possible to confirm how the independent variable affects the dependent variable.

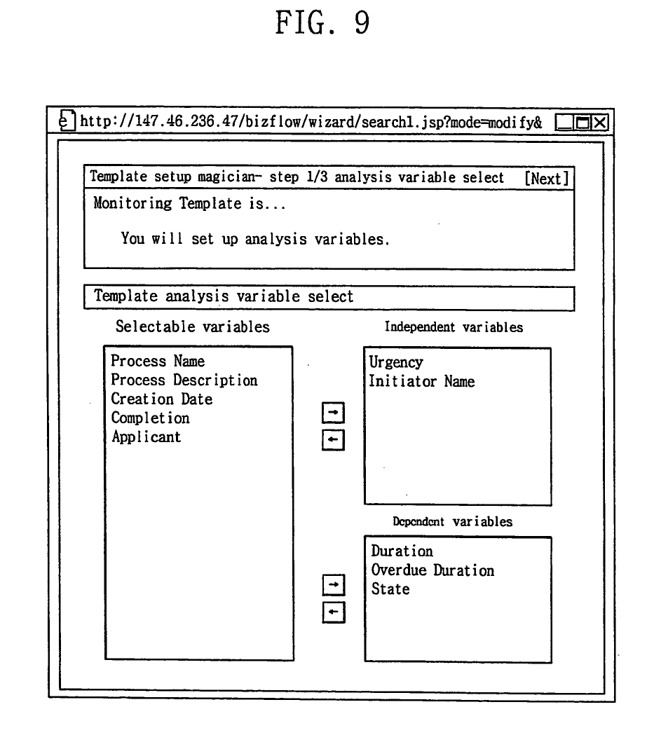

FIG. 9 is a view illustrating a picture for explaining a process for selecting the independent variables and dependent variables by the variable setup module of the operation module. All the variables for analysis of each template are shown in a selectable variable box window. In this embodiment, the selectable variable box window has the process name, process description, creation date, completion data, urgency, initiator name, duration, overdue duration, state and applicant of the process archive template. The user selects the urgency and initiator name as the independent variables and the overdue duration and state as the dependent variables. When the analysis is executed by the analysis execute module in the analysis conditions, the effectiveness of the independent variables on the dependent variables can be systematically analyzed.

The variable setup module also provides a function of setting up the independent variables.

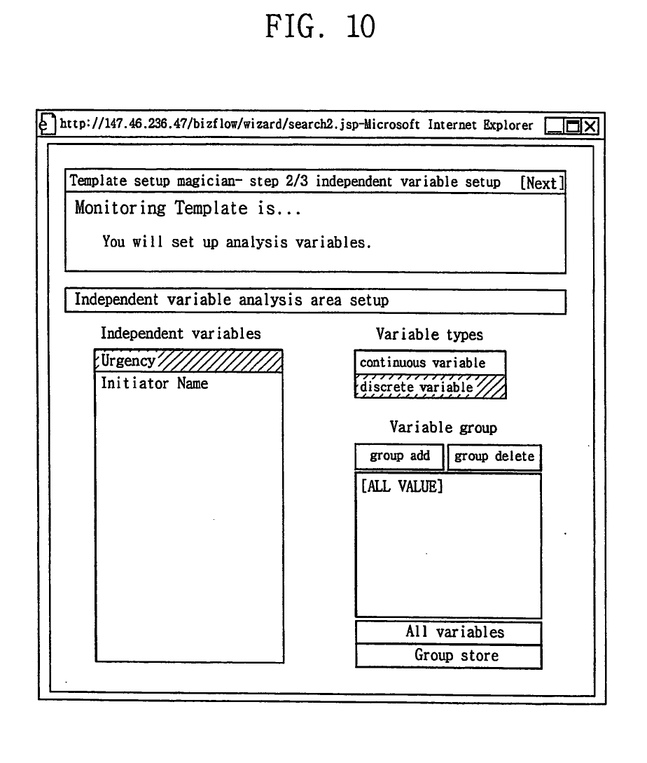

FIG. 10 is a view illustrating an example of setting up the independent variables by the variable setup module. The independent variables are divided into continuous variables and discrete variables. The continuous variable has a value of a continuous period, and the discrete variable has a non-continuous value. For example, when the user intends to designate a specific date, the variable such as the creation date or completion date becomes the discrete variable, and when the user intends to designate a specific period, it becomes the continuous variable. Therefore, the user selects the independent variable, designates the continuous variable or discrete variable in a variable type, and inputs the designated value into a variable group window.

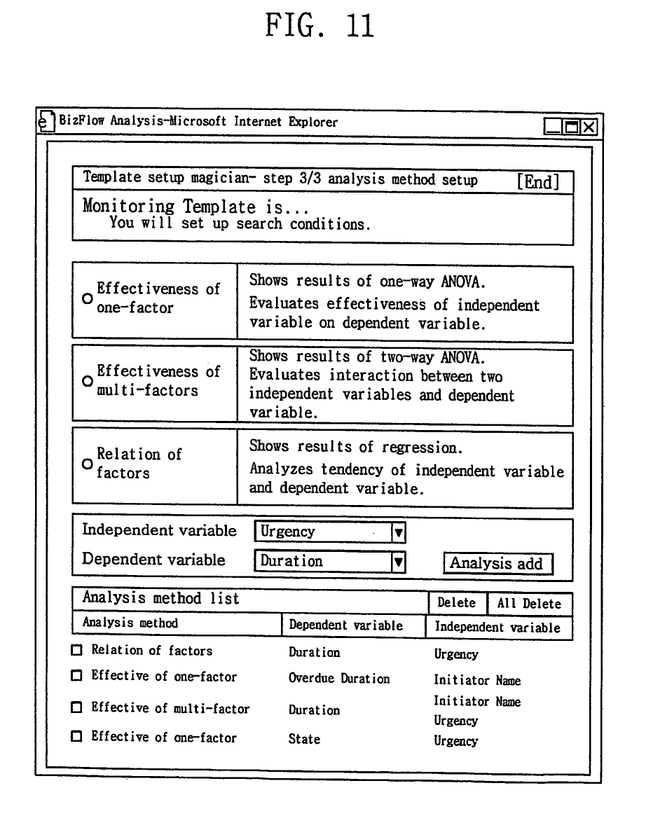

FIG. 11 is a view illustrating an initial screen provided by the analysis method setup module of the operation module. When the setup of the analysis variables is finished by the variable setup module, the analysis method setup module is driven to set up the analysis method. In accordance with the preferred embodiment of the invention, three analysis methods are suggested. First of all, a one-way analysis of variance (ANOVA) analyzes the effectiveness of one independent variable on one dependent variable. Second, a two-way ANOVA analyzes interaction between at least two independent variables and one dependent variable. Third, a regression method analyses a trends of the independent and dependent variables. When the user selects one of the analysis methods by the analysis method setup module, the selected analysis method is set up in the template.

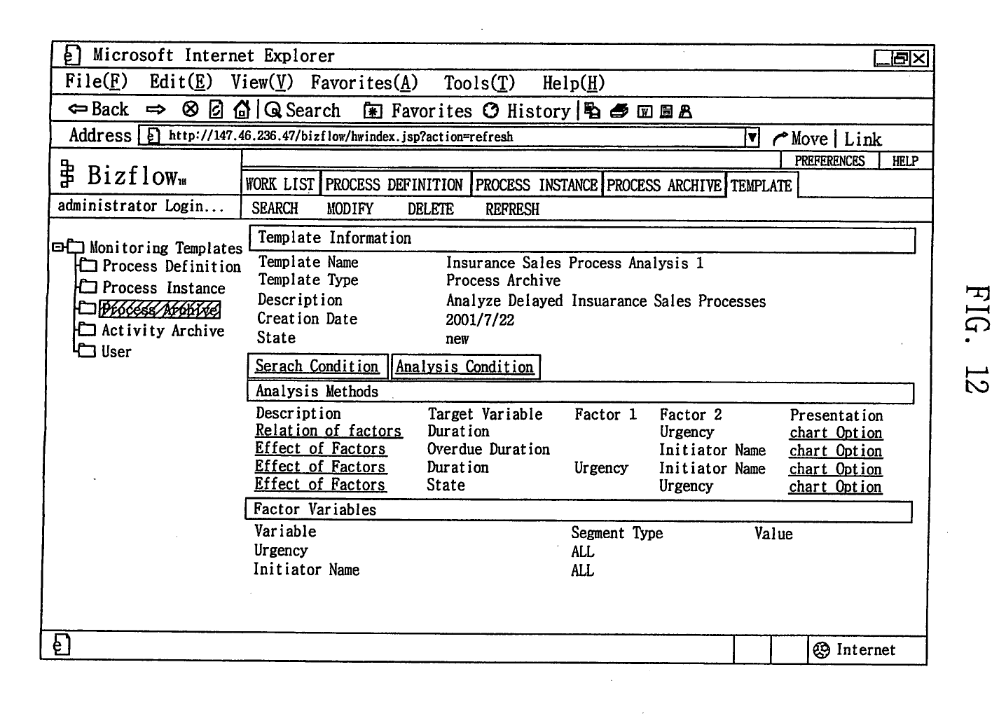

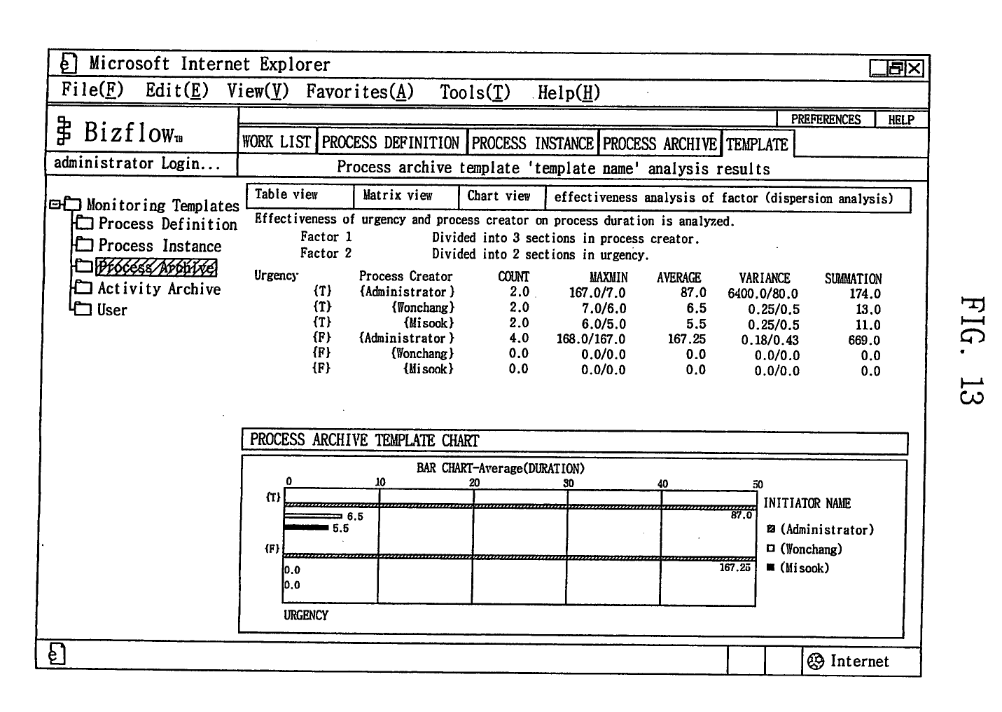

FIG. 12 is a view illustrating a picture displayed by opening the template whose analysis variables and analysis method are set up by the operation module. FIG. 12 shows the analysis method for analyzing the effectiveness of the two independent variables, namely factor 1 ‘urgency’ and factor 2 ‘initiator name’ on the dependent variable, namely ‘duration’ of the target value among the four analysis methods. When the hyper-linked description of the analysis method is executed in FIG. 12 (for example, by double-clicking), the analysis execute module is driven to execute the analysis according to the designated analysis method and extract the analysis results as shown in FIG. 13.

FIG. 13 shows the effectiveness of the two independent variables, urgency and initiator or creator name on the dependent variable, duration The duration is displayed in various forms of MAX/MIN, AVERAGE, VARIANCE and SUMMATION. The averages are shown in a bar graph. The analysis execute module shows the analysis results in a basically-prepared presentation type.

The presentation of the analysis results can be modified in a form desired by the user by driving the presentation module. The presentation module is driven by selecting ‘chartoption’ of FIG. 12. It is obvious that such a driving method can be variously modified by those skilled in the art.

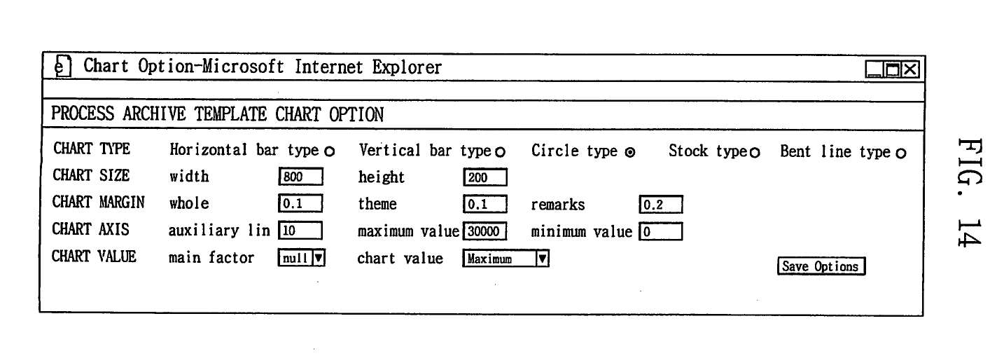

FIG. 14 is a view illustrating a picture for enabling the user to set up the presentation type by driving the presentation module. As shown in FIG. 14, the presentation module provides a variety of options for presentation, including a chart form, chart size, chart margin, chart axis and chart value, so that the user can select them The options set up by the user are stored in the template, and the stored chart options are used to drive the analysis execute module for presentation.

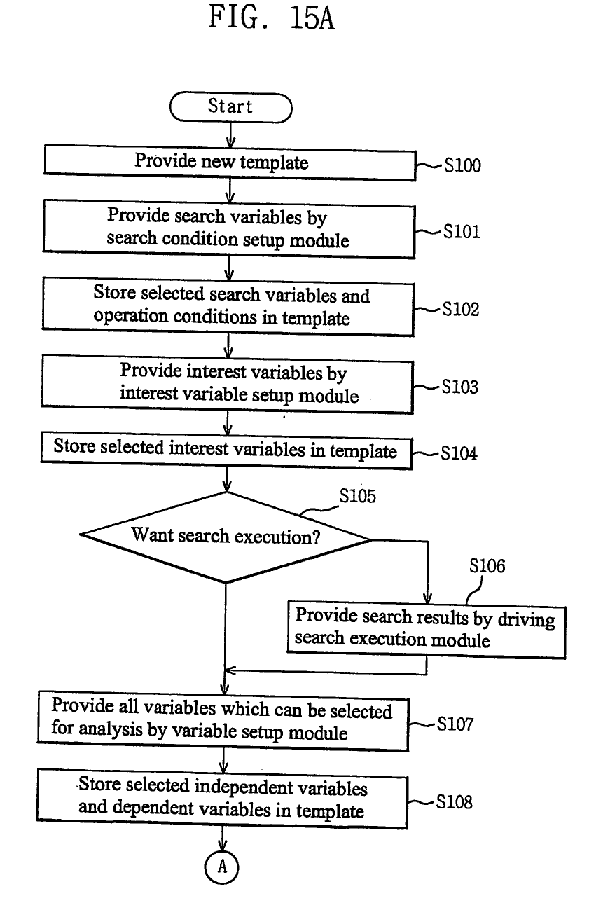

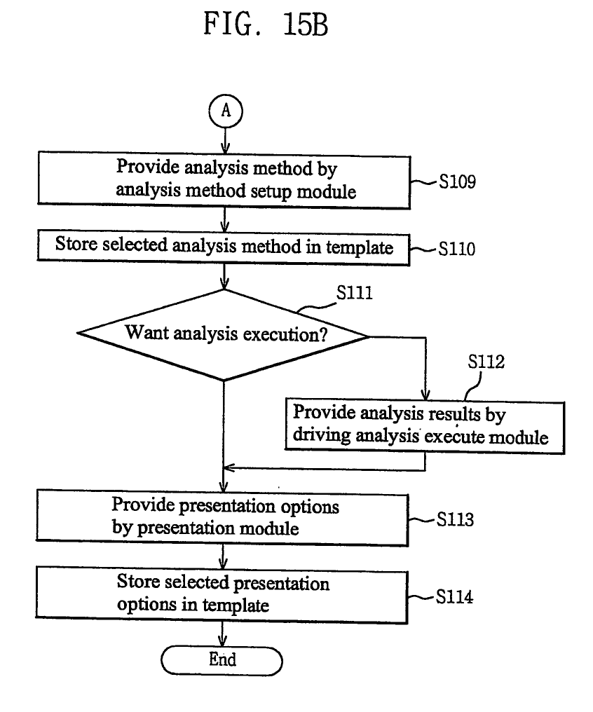

FIGS. 15a and 15b are flowcharts showing sequential steps of the method for creating the personalized template for monitoring the workflows in accordance with the present invention.

When the user drives the template create module of the template management module (for example, by clicking ‘new’ button of the menu window), the template create module provides a new template so that the user can create the personalized template for monitoring the workflows (S100).

When the new template is provided and the user selects the menu for setting up the search conditions, the search condition setup module of the data object module is driven to provide the search variables divided into the basic variables, derived variables and process variables for each template (S101). When the user selects the search variables and sets up the operation conditions of the search variables, the search condition setup module stores them in the template (S102).

In order to designate the interest items in the search results, the interest variables are set up. For this, when the user drives the interest variable setup module, the interest variable setup module provides the interest variables divided into the basic variables, derived variables and process variables for each template (S103), and stores the interest variables selected by the user in the template (S104).

Thereafter, the user executes the search by driving the search execute module according to the search conditions and interest variables set up by the user (S105 and S106). Otherwise, the routine goes to a step for setting up the analysis variables and analysis method by the operation module without executing the search.

When the user drives the variable setup module of the operation module, the variable setup module provides all the variables which can be selected for analysis (S107), enables the user to individually select the independent and dependent variables, and stores the selected independent and dependent variables in the template (S108). In addition, the variable setup module divides the independent variables into the continuous variables and discrete variables, and stores a range of the continuous variable or a value of the discrete variable set up by the user in the template.

When the setup of the conditions of the analysis variables is finished, the analysis method setup module is driven to set up the analysis method by the analysis variables. As set forth above, the analysis method setup module provides the one-way ANOVA, the two-way ANOVA and the regression method as the analysis methods (S109), and stores the analysis method selected by the user in the template (S110).

Here, the user can execute the analysis on the basis of the analysis variable condition and analysis method set up by the user. The analysis is executed according to two methods; the analysis results can be displayed in a basically-provided presentation format of the analysis execute module (S111 and S112), or in a wanted format of the user by driving the presentation module. In the case that the user drives the presentation module, the presentation module provides a variety of options including the chart form, chart size, chart margin, chart axis and chart value so that the user can select them (S113), and stores the selected options in the template (S114). The presentation conditions set up by the presentation module are used to drive the analysis execute module for presentation.

As the present invention may be embodied in several forms without departing from the spirit or essential characteristics thereof it should also be understood that the above-described embodiment is not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds are therefore intended to be embraced by the appended claims.

As discussed earlier, in accordance with the preset invention, the users monitoring workflows in the workflow system can individually set up the search conditions and analysis conditions in the templates, thereby efficiently analyzing the works.

Moreover, the user can frequently set up the presentation conditions of the search and analysis results obtained according to the setup search and analysis conditions.

What is claimed is:

1. A system for creating a personalized template for monitoring workflows which is mounted on a workflow server including a workflow engine and a database, comprising:
a template management module for performing functions of creating a new template, opening and using the template, modifying the template and deleting the template;
a data object module for providing a user with search variables for setting up search conditions on the template and interest variables for interest items for selecting wanted items from the searched results, storing the search conditions and interest variables set up by the user, and executing search; and
an operation module for providing analysis variables and an analysis method for analysis on the basis of the search variables and interest variables set up in the data object module, and executing analysis according to the selected analysis variables and analysis method.

2. The system according to claim 1, further comprising a presentation module for setting up a presentation format of the analysis results obtained by the operation module upon the user's request.

3. The system according to claim 1, wherein the data object module comprises:
a search variable setup module for providing the search variables for setting up the search conditions; and
an interest variable setup module for providing the interest variables for interest items for selecting wanted items from the searched results, the search variables and the interest variables being composed of basic variables basically provided for each template and simply read from the database, and derived variables relating to values obtained by operating more than 2 data values stored in the database.

4. The system according to claim 1, wherein the analysis variables provided by the operation module comprise dependent variables indicating items which the user intends to read from the analysis results, and independent variables having an effect on the dependent variables.

5. A method for creating a personalized template for monitoring workflows which is mounted on a workflow server including a workflow engine and a database, comprising the steps of:
(a) providing a new template for creating the personalized template;
(b) providing search variables for setting up search conditions according to kinds of templates, and storing the search variables selected by the user and operation conditions of the search variables in the template;
(c) providing items which the user intends to read from the search results as interest variables, and storing the interest variables selected by the user in the template; and
(d) providing analysis variables and an analysis method for analysis on the basis of the search variables and the interest variables set up in step (b), and storing the selected analysis variables and analysis method in the template.

6. The method according to claim 5, further comprising a step for providing a variety of presentation options to the user to set up a presentation format of the analysis results obtained by the analysis variables and analysis method, and storing the selected options in the template after step (d).

7. The method according to claim 5, wherein the search variables and the interest variables comprise basic variables basically provided for each template and simply read from the database, and derived variables relating to values obtained by operating more than 2 data values stored in the database.

8. The method according to claim 5, wherein the analysis variables comprise dependent variables indicating items which the user intends to read from the analysis results, and independent variables having an effect on the dependent variables.
